(19) United States
(12) Patent Application Publication
(10) Pub. No.: US 2005/0081100 A1
(43) Pub. Date: Apr. 14, 2005

(54) System and method for automatically initializing and diagnosing backplanes of electronic devices

(76) Inventors: Xin Zeng, Shenzhen (CN); Tang He, Shenzhen (CN)

Correspondence Address: WEI TE CHUNG;FOXCONN INTERNATIONAL, INC., 1650 MEMOREX DRIVE, SANTA CLARA, CA, 95050, US

(21) Appl. No.: 10/830,209

(22) Filed: Apr. 21, 2004

(30) Foreign Application Priority Data
Sep. 26, 2003 (TW) 92126624

(51) Int. Cl. G06F 11/00

(52) U.S. Cl. 714/25

(57) ABSTRACT

A system (3) for automatically initializing and diagnosing backplanes of electronic devices includes a monitor (1) and a driver (2) connected with the monitor. The monitor includes a command editor (10) for receiving diagnosis commands inputted by users, a command translator (11) connected with the command editor for compiling the diagnosis commands into binary commands, a processing unit (13) connected with the command translator for running diagnosis programs, and a display unit (14) connected with the command editor for displaying information. The driver includes an initialization module (20) for initializing the backplane, and a diagnosis module (21) connected with the processing unit and the display unit for providing diagnosis programs. A related method for automatically initializing and diagnosing a backplane of an electronic device is also provided.

### BACKGROUND OF THE INVENTION

1. Field of the Invention

The present invention relates to systems and methods for diagnosing computer hardware devices, and more particularly to systems and methods for automatically initializing and diagnosing backplanes of electronic devices.

2. Description of Related Art

Generally, network communication electronic devices such as routers and switches have backplanes. In order to ensure that the electronic devices work well, it is necessary to perform tests on the backplanes thereof after various chips and hardware have been installed on the backplanes. The chips typically include central processing units (CPUs), memory modules, and so on. The hardware typically includes Ethernet ports, universal serial bus (USB) interfaces, and so on. In the process of testing, the electronic devices under test provide different test signals for the backplanes. Simultaneously, the electronic devices receive response signals from the backplanes. The electronic devices compare the response signals with benchmark signals, and then determine whether the backplanes are satisfactory. Electronic devices with satisfactory backplanes are then ready for use. If any backplanes are not satisfactory, they are repaired or discarded.

China. Pat. No. 1,371,062, published on Sep. 25, 2002, discloses a portable apparatus for diagnosing electronic devices. The portable apparatus comprises a communication module, a memory, a processor for running a control program stored in the memory, an output/input port for transmitting signals to the electronic devices and for receiving signals from the electronic devices, a display unit for displaying information to users, and a control panel for providing an operation interface for the users. Although the portable apparatus can diagnose the electronic devices, the portable apparatus cannot initialize the electronic devices. The users need to initialize the electronic devices prior to performing the diagnosis. When there are numerous electronic devices needing diagnosis, it is time consuming for the users to initialize all the electronic devices.

What is needed is a system and method which can both initialize and diagnose backplanes of electronic devices.

### SUMMARY OF THE INVENTION

Accordingly, a primary object of the present invention is to provide a system for automatically initializing and diagnosing backplanes of electronic devices.

Another object of the present invention is to provide a method for automatically initializing and diagnosing a backplane of an electronic device.

In order to fulfill the above-mentioned primary object, the present invention provides a system for automatically initializing and diagnosing backplanes of electronic devices. The system comprises a monitor, and a driver connected with the monitor. The monitor comprises a command editor for receiving diagnosis commands inputted by users, a command translator connected with the command editor for compiling the diagnosis commands into binary commands, a processing unit connected with the command translator for running diagnosis programs, and a display unit connected with the command editor for displaying information. The driver comprises an initialization module for initializing the backplane, and a diagnosis module connected with the processing unit and the display unit for providing diagnosis programs.

In order to fulfill the other above-mentioned object, the present invention provides a method for automatically initializing and diagnosing a backplane of an electronic device. The method comprises the following steps: (a) initializing the backplane; (b) compiling a diagnosis command into a binary command, and transmitting the binary command to a processing unit; and (c) running a corresponding diagnosis program to diagnose the backplane according to the binary command.

Other objects, advantages and novel features of the present invention will become more apparent from the following detailed description when taken in conjunction with the accompanying drawings, in which:

### BRIEF DESCRIPTION OF THE DRAWINGS

FIG. 1 is a schematic diagram of hardware infrastructure of the system for automatically initializing and diagnosing backplanes of electronic devices according to the present invention;

FIG. 2 is a flow chart of an exemplary method for automatically initializing a backplane of an electronic device according to the present invention; and

FIG. 3 is a flow chart of an exemplary method for diagnosing a backplane of an electronic device according to the present invention.

### DETAILED DESCRIPTION OF THE INVENTION

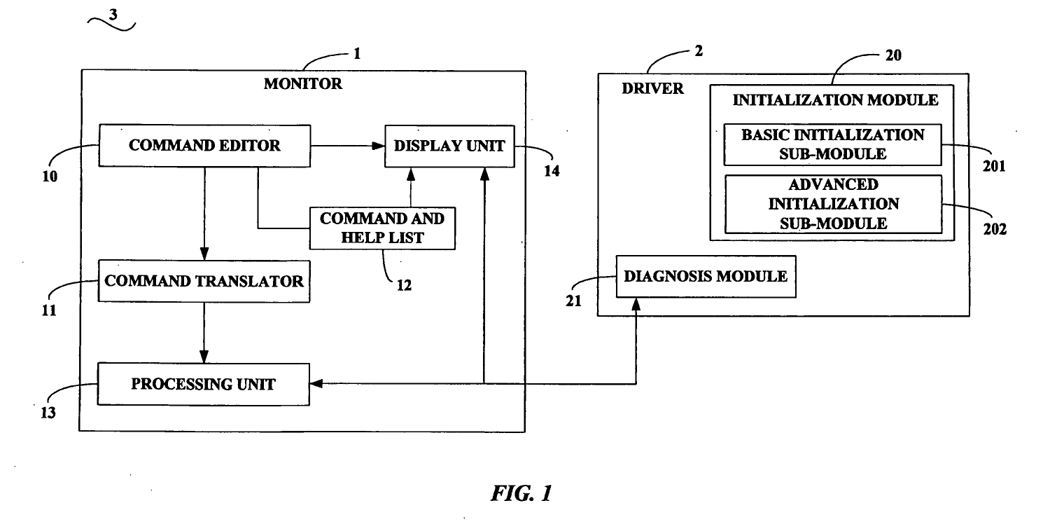

FIG. 1 is a schematic diagram of hardware infrastructure of a system 3 for automatically initializing and diagnosing backplanes of electronic devices according to the present invention. In the exemplary embodiment of the present invention, each backplane is not initialized. The system 3 comprises a monitor 1, and a driver 2 connected with the monitor 1. The monitor 1 comprises a command editor 10 for receiving diagnosis commands inputted by a user, a command translator 11 connected with the command editor 10 for compiling the diagnosis commands into binary commands, a command and help list 12 connected with the command editor 10 for defining formats and contents of the commands, a processing unit 13 connected with the command translator 11, and a display unit 14 connected with the command editor 10 and the command and help list 12 for displaying information to the user.

When the user inputs a first letter of a diagnosis command, the command and help list 12 transmits all corresponding diagnosis commands with the same first letter as the one inputted by the user to the display unit 14. The display unit 14 displays the corresponding diagnosis commands, from which the user can select the one that he/she needs. The processing unit 13 is for running corresponding diagnosis programs according to the binary commands transmitted by the command translator 11. The diagnosis programs are stored in the driver 2. The display unit 14 may be a monochrome liquid crystal display (LCD), a multicolor LCD, or any other suitable display. The user monitors a work status of the system 3 by using the display unit 14, and determines what to do based on the work status of the system 3.

The driver 2 comprises an initialization module 20 for initializing the backplane of the electronic device, and a diagnosis module 21 for providing different diagnosis programs. The initialization module 20 comprises a basic initialization sub-module 201 and an advanced initialization sub-module 202. The basic initialization sub-module 201 is used for initializing chips such as a central processing unit (CPU) and memory modules on the backplane. The advanced initialization sub-module 202 is provided for initializing hardware such as Ethernet ports and universal serial bus (USB) interfaces on the backplane. The advanced initialization sub-module 202 also initializes the port of a universal asynchronous receiver-transmitter (UART) of the backplane, and tests UART registers and CPU registers of the backplane. The diagnosis module 21 provides the different diagnosis programs for various chips and hardware on the backplane. After running the diagnosis programs, the processing unit 13 generates diagnosis results. The diagnosis module 21 returns the diagnosis results to the display unit 14, and the display unit 14 displays the diagnosis results to the user.

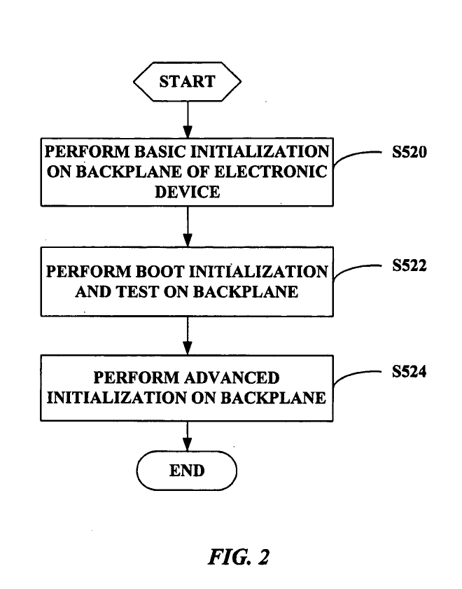

FIG. 2 is a flow chart of the exemplary method for automatically initializing a backplane of an electronic device according to the present invention. At step S520, the basic initialization sub-module 201 performs a basic initialization on the backplane. The basic initialization comprises initialization of the chips such as the central processing unit (CPU) and memory modules on the backplane. At step S522, the advanced initialization sub-module 202 performs a boot initialization and test on the backplane. The boot initialization and test is to initialize the port of the UART of the backplane, and test the UART registers and CPU registers of the backplane. At step S524, the advanced initialization sub-module 202 performs an advanced initialization on the backplane. The advanced initialization is to initialize the hardware such as an Ethernet port and a universal serial bus (USB) interface of the backplane.

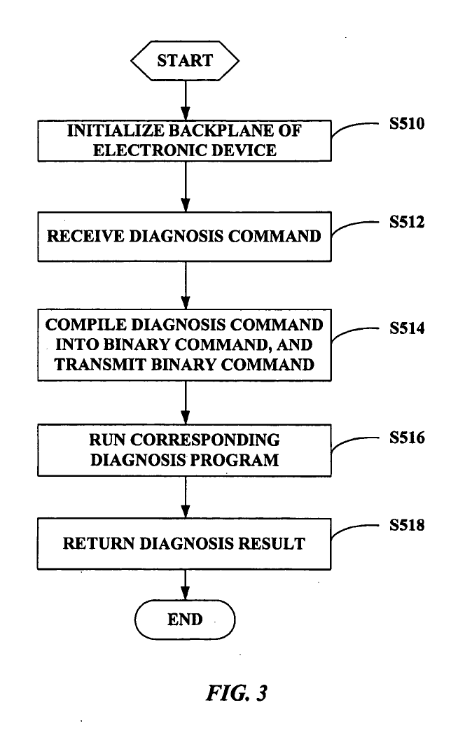

FIG. 3 is a flow chart of the exemplary method for diagnosing a backplane of an electronic device according to the present invention. The backplane is connected to the driver 2. At step S510, the driver 2 initializes the backplane. At step S512, the command editor 10 receives a diagnosis command inputted by a user. At step S514, the command translator 11 compiles the diagnosis command into a binary command, and transmits the binary command to the processing unit 13. At step S516, the processing unit 13 runs a corresponding diagnosis program to diagnose the backplane according to the binary command. The corresponding diagnosis program is stored in the diagnosis module 21. At step S518, the diagnosis module 21 returns a diagnosis result to the display unit 14. The display unit 14 displays the diagnosis result to the user.

While a preferred embodiment and preferred methods of the present invention have been described above, it should be understood that they have been presented by way of example only and not by way of limitation. Thus the breadth and scope of the present invention should not be limited by the above-described exemplary embodiment and methods, but should be defined only in accordance with the following claims and their equivalents.

1. A system for automatically initializing and diagnosing backplanes of electronic devices, the system comprising:
a monitor comprising:
a command editor for receiving diagnosis commands inputted by users;
a command translator connected with the command editor for compiling the diagnosis commands into binary commands;
a processing unit connected with the command translator for running diagnosis programs; and
a display unit connected with the command editor for displaying information; and
a driver connected with the monitor, the driver comprising:
an initialization module for initializing the backplane; and
a diagnosis module connected with the processing unit and the display unit for providing diagnosis programs.

2. The system as claimed in claim 1, wherein the monitor further comprises a command and help list connected with the command editor and the display unit for defining formats and contents of the diagnosis commands.

3. The system as claimed in claim 1, wherein the processing unit runs corresponding diagnosis programs according to the binary commands transmitted by the command translator.

4. The system as claimed in claim 1, wherein the diagnosis programs are stored in the diagnosis module of the driver.

5. The system as claimed in claim 1, wherein the display unit is a monochrome liquid crystal display.

6. The system as claimed in claim 1, wherein the display unit is a multicolor liquid crystal display.

7. The system as claimed in claim 1, wherein the initialization module comprises:
a basic initialization sub-module for initializing one or more chips of the backplane; and
an advanced initialization sub-module for initializing hardware of the backplane.

8. The system as claimed in claim 7, wherein the advanced initialization sub-module is for performing a boot initialization and test on the backplane.

9. The system as claimed in claim 1, wherein the diagnosis module provides corresponding diagnosis programs for different chips and hardware of the backplane.

10. A method for automatically initializing and diagnosing a backplane of an electronic device, the method comprising the following steps:
(a) initializing the backplane;
(b) compiling a diagnosis command into a binary command, and transmitting the binary command to a processing unit; and
(c) running a corresponding diagnosis program to diagnose the backplane according to the binary command.

11. The method as claimed in claim 10, further comprising the following step after step (a): receiving a diagnosis command inputted by a user.

12. The method as claimed in claim 10, further comprising the following step after step (c): returning diagnosis result to a display unit.

13. The method as claimed in claim 10, wherein step (a) comprises the following steps:
(a1) performing a basic initialization on the backplane;
(a2) performing a boot initialization and test on the backplane; and
(a3) performing an advanced initialization on the backplane.

14. The method as claimed in claim 13, wherein step (a1) comprises the step of initializing one or more chips of the backplane.

15. The method as claimed in claim 13, wherein step (a3) comprises the step of initializing hardware of the backplane.

16. A system for automatically initializing and diagnosing backplanes of electronic devices, the system comprising:
a monitor comprising:
a processing unit for running diagnosis programs; and
a display unit for displaying information; and
a driver connected with the monitor, the driver comprising:
an initialization module for initializing the backplane; and
a diagnosis module connected with the processing unit and the display unit for providing diagnosis programs; wherein
said backplanes have not been initialized before the system is run.
